(19) United States
(12) Patent Application Publication
(10) Pub. No.: US 2023/0359191 A1
(43) Pub. Date: Nov. 9, 2023

(54) SYSTEM AND METHOD FOR DETERMINING A CAUSE OF AN OPERATING ANOMALY OF A MACHINE, COMPUTER PROGRAM AND ELECTRONICALLY READABLE DATA STORAGE DEVICE

(71) Applicant: Siemens Aktiengesellschaft, 80333 München (DE)

(72) Inventors: CHRISTIAN DEEG, Altdorf (DE); MICHAEL LEIPOLD, Nürnberg (DE); MATTHIAS MANGER, Fürth (DE); BERND WACKER, Herzogenaurach (DE)

(73) Assignee: Siemens Aktiengesellschaft, 80333 München (DE)

(21) Appl. No.: 18/022,927

(22) PCT Filed: Aug. 6, 2021
(86) PCT No.: PCT/EP2021/072047

§ 371 Date: Feb. 23, 2023

(30) Foreign Application Priority Data
Aug. 24, 2020 (EP) 20192353.9

(51) Int. Cl. G05B 23/02

(52) U.S. Cl. CPC G05B 23/0281; G05B 23/024

(57) ABSTRACT

A method, a system, a computer program and a data storage device in which machine parameters are captured by at least one sensor of the machine are disclosed. The operating anomaly is identified via the captured machine parameters. Environmental parameters are retrieved from at least one external data source and the captured machine parameters are retrieved by a computing device. The environmental parameters are filtered at least according to a location of the machine and/or a measuring time of the machine parameters, Furthermore, at least one correlation between the machine parameters, the filtered environmental parameters and the operating anomaly is ascertained by the computing device by a correlation model. The cause of the operating anomaly is determined on the basis of the at least one correlation ascertained by the correlation model.

The invention relates to a method for determining a cause of an operating anomaly of a machine, a system with a machine and a computing facility, a computer program, which can be loaded directly in a memory of a computing facility, and an electronically readable data storage device with control information for a computer program stored thereupon.

Diagnosing damage or wear and tear on a machine, in particular on a drive system is complicated by unknown external influences. These external causes can be found in anomalies, the cause of which is not measured by the machine, since the machine only has a limited number of sensors and it is not possible to take account of all environmental parameters. In some circumstances, existing sensors of the machine can also supply incorrect values or no values.

Environmental parameters or external parameters are usually unknown when diagnosing a machine, Environmental parameters are, for example, ambient conditions such as atmospheric humidity, heat, weather influences, influences from external machines such as, for example, vibrations, explosions and/or effects that do not stem from the actual task of the machine. An operating anomaly consists of atypical machine parameters, i.e., measured values. These anomalies can be actual values or also stem from sensor errors. For example, a defective sensor can display a temperature that is too high and does not actually exist.

Since, for the most part, a machine manufacturer does not know how the machines are used, where they are located and the conditions in which they are operated, it is frequently difficult to determine the cause of an operating anomaly and to date it has only been possible to determine the cause by manual investigations,

It is the object of the present invention to determine a cause of an operating anomaly of a machine.

According to the invention, this object is achieved by the subject matter of the independent claims. Advantageous embodiments and developments of the invention are disclosed in the dependent claims, the following description and the figures,

The invention is based on the knowledge that one or more correlations of machine parameters with environmental parameters enable statements to be made regarding the operating anomaly, for example whether or not the machine is being operated in its intended operating range and whether or not it has been set up as intended. The use of environmental parameters can supplement missing information about the operating anomaly thus enabling the cause to be determined.

The invention provides a method for determining a cause of an operating anomaly of a machine. A machine can be a drive system such as, for example, a motor or a generator coupled to a production machine in an industrial environment. In general, it can in particular be an electric, pneumatic and/or hydraulic drive. The method can also be applied to individual components of the machine, in particular in order to control the machine.

The method comprises capturing machine parameters by at least one sensor of the machine, identifying the operating anomaly from the captured machine parameters and retrieving environmental parameters from at least one external data source and the captured machine parameters by a computing facility, wherein the environmental parameters are filtered at least in dependence on a location of the machine and/or a measurement time of the machine parameters.

In other words, the machine has at least one sensor with which machine parameters, i.e., operating data, can be measured. The sensor can, for example, be an optical, electrical, acoustic and/or mechanical sensor capable of monitoring the intended operation of the machine. Preferably, a number of sensors are provided which monitor or capture a plurality of machine parameters. These captured machine parameters can be used to detect and identify the operating anomaly.

Herein, the operating anomaly can be an error message or a measured machine parameter that is not typical of the operation of the machine. The captured machine parameters can be retrieved together with environmental parameters from at least one external data source by a computing facility for further processing. Preferably, the computing facility can also cause the machine to measure the machine parameters and send them to the computing facility. Furthermore, it can preferably be provided that the computing facility identifies the operating anomaly from the captured machine parameters, for example by checking the machine parameters for compliance with predetermined operating ranges.

The external data source can be cloud computing comprising one or more computers and/or servers that record macroscopic data about the environment, in particular using sensors external to the machine. Preferably, the environmental parameters can be retrieved from public or external databases and information sources that can display weather information, earthquake information, economic information such as, for example, local energy costs, information from utility companies about grid problems and utility reliability. Information can also be obtained from accessible social networks from which information about the machine's environment can be inferred.

In order to limit the number of environmental parameters for further-processing by the computing facility, the environmental parameters can be filtered at least in dependence on a location of the machine and/or a measurement time of the machine parameters, This means that the computing facility can first synchronize and homogenize the environmental parameters in terms of time and can enrich a database of the computing facility for further processing. Homogenization means filtering according to the location of the machine and/or the measurement time of the machine parameters. However, homogenization can also comprise parameter or data cleaning according to data quality, standardization of data and removal of duplicates, Herein, the filtering of the location and/or the measurement time can be adapted to the type of environmental parameters in a suitable way.

Retrieval of the environmental parameters is followed by a method step of ascertaining at least one correlation between the machine parameters, the filtered environmental parameters and the operating anomaly by the computing facility by means of a correlation model and determining the cause of the operating anomaly based on the at least one correlation ascertained by the correlation model. Therefore, the computing facility is configured to execute a correlation model. During the execution of the correlation model, the model ascertains at least one correlation between the machine parameters, the filtered environmental parameters and the operating anomaly. This means that the computing facility checks whether a correlation with the operating anomaly can be found between the machine parameters and the filtered environmental parameters and, if such a correlation is found, the cause of the operating anomaly can be derived therefrom. For this purpose, preferably a correlation model can be provided in which known correlations are modeled and unknown correlations can be ascertained by statistical analysis. This means that known relationships and/or relationship knowledge for the correlation model that are known from historical data can be incorporated. In other words, the correlation model can be constructed on the basis of a comparison of previous experience together with a comparison of new correlations. Hence, previous experience, i.e., known correlations, can be enriched with new correlations thus increasing the probability of determining the cause of the operating anomaly.

The correlation, preferably plurality of correlations, found in this way enables the cause of the operating anomaly to be ascertained in an improved manner, preferably in an automated manner, based on the correlations found. Alternatively or additionally, the one or more correlations can be processed and visualized in a semantic network, wherein new correlations can be represented as new knowledge paths or existing knowledge paths can be reduced based on newly obtained knowledge from the correlation ascertainment if no correlation is found. The semantic network can preferably serve as a template for the correlation model.

The detected cause of the operating anomaly can be used to derive a proposal for optimization and action, in particular, it is possible to forecast as to how the cause will affect the operation of the machine. Hence, it is possible to take action on the machine or the machine's installation site, for example on the factory in which the machine has been installed, This means that, for example, an alert, throttling or shutdown can be initiated.

The computing facility with which the environmental parameters and the machine parameters are retrieved and with which the at least one correlation is ascertained can preferably be a computer external to the machine, in particular a server provided in a data network, for example the Internet.

The invention has the advantage that it enables a statement to be made regarding a cause of an operating anomaly, even though the machine itself does not have suitable sensors for detecting the cause. It is hence possible to make forecasts and diagnoses in an improved manner and possible damage to the machine can be prevented or reduced in advance since a known cause can be counteracted at an early stage. In addition, if damage has already occurred, it is possible to check whether it is a warranty case, an insurance case or a case of wear and tear.

In an advantageous embodiment of the present invention, it is provided that the at least one correlation is ascertained by statistical analysis. In particular, new unknown correlations can be sought by means of statistical analysis. The statistical analysis can preferably comprise outlier detection, duster analysis, classification of the machine parameters and the environmental parameters, association analysis and/or regression analysis. Preferably, regression analysis can be used to determine a relationship, i.e., for data pattern detection, from minimization of a predetermined model function. For this purpose, the correlation model can have a predetermined function that is examined for the presence of a correlation between the machine parameters and the environmental parameters, for example, by means of the least squares method. This embodiment has the advantage that unknown and new correlations can be ascertained and hence the determination of the cause of the operating anomaly can be improved.

Preferably, it is provided that the correlation model is modeled in dependence on known relationships and/or known constraints. In this way, for ascertaining the at least one correlation, the underlying knowledge paths of the correlation model can be reduced or specifically evaluated in order to keep computing power and computing time within limits. In other words, the machine parameters and, in particular, the environmental parameters used for analysis by the computing facility can be limited by dispensing with analysis for parameters with known constraints and/or selectively retrieving parameters with known relationships, i.e., with known correlations, from the external data source. Hence, the data can be further filtered before processing by the computing facility.

Furthermore, it is advantageously provided that the correlation model is adapted by a machine learning function if a new correlation is detected for the cause of the operating anomaly. In particular, the machine learning function can iteratively adapt and improve the correlation model in an automated manner by means of known relationships and/or known constraints. This results in the advantage that the ascertainment of the at least one correlation can be accelerated and performed particularly efficiently.

In an advantageous development of the method, it is provided that the cause of the operating anomaly is determined in dependence on a predetermined correlation pattern by the computing facility by means of artificial intelligence, wherein the machine parameters and the environmental parameters are examined for the presence of the predetermined correlation pattern. This means that the artificial intelligence examines the machine parameters and the environmental parameters for known correlations predetermined by the correlation pattern. If a match for the correlation pattern is found, the artificial intelligence can identify the cause of the operating anomaly automatically. The artificial intelligence can, for example, be based on a neural network that examines the parameters for the presence of the predetermined correlation pattern. This development results in the advantage that the detection of the cause of the operating anomaly can be performed in an automated manner, which contributes to an acceleration of the method.

It is advantageously provided that the environmental parameters are measured by external environmental sensors. In other words, the external data source can collect and store environmental parameters recorded by external environmental sensors. ‘External environmental sensors’ means sensors that do not belong to the machine, but, for example, belong to facilities in the area surrounding the machine. The environmental sensors provided can, for example, be weather sensors that measure temperature, precipitation or snow fall and/or atmospheric humidity. In addition, environmental sensors can comprise current sensors, seismic sensors, sensors from other machines or factories and/or gas sensors. This results in the advantage that the sensors of the machine can be extended by further environmental sensors without installing them in the machine, thus enabling costs to be saved.

In an advantageous development of the present invention, it is provided that a control signal with which a machine function of the machine or another machine is actuated is generated in dependence on the cause of the operating anomaly. In other words, a respective predetermined control signal with which the one or more machines can be actuated can be generated for one or more predetermined causes of the operating anomaly. For example, when the cause of the operating anomaly is detected, a control signal can be generated that can throttle or shut down the machine and/or other machines in the vicinity. Alternatively or additionally, the control signal can also trigger an alert in the machine or a factory where the machine is located. In addition, the control signal can provide an all-clear, for example if it is identified that the operating anomaly is a cause that is harmless to the machine. This development results in the advantage that it is possible to react quickly to operating anomalies in an automated manner as a result of which damage to the machine can be avoided or operation of the machine can be maintained.

A further aspect of the invention relates to a system for determining a cause of an operating anomaly of a machine, with the machine and a computing facility, wherein the machine is embodied to capture machine parameters by at least one sensor and to identify an operating anomaly from the captured machine parameters, wherein the computing facility is embodied to retrieve environmental parameters from at least one external data source and the captured machine parameters, wherein the environmental parameters are filtered at least in dependence on a location of the machine and/or a measurement time of the machine parameters, to ascertain at least one correlation between the machine parameters, the filtered environmental parameters and the operating anomaly by means of a correlation model and to determine the cause of the operating anomaly based on the at least one correlation ascertained by the correlation model. The developments of the method and the corresponding advantages can each be transferred analogously to the system according to the invention. Therefore, the invention also includes developments of the method according to the invention with embodiments that are not explicitly described here in the respective combination in order to avoid unnecessary redundancy.

A further aspect of the invention is a computer program according to the invention, which implements a method according to the invention on an electronic computing facility. Herein, the computer program can also be present in the form of a computer program product, which can be loaded directly into a memory of a computing facility. The computer program product has program code means for executing a method according to the invention when the computer program product is executed in or by the computing facility.

A further aspect of the invention relates to an electronically readable data storage device. Herein, the electronically readable data storage device according to the invention comprises electronically readable control information stored thereupon, which comprises at least one computer program according to the invention or is embodied such that it performs a method according to the invention when the data storage device is used in a computing facility.

Further advantages, features and details of the invention will be apparent from the following description of preferred exemplary embodiments and with reference to the drawings.

The present invention will now be explained in more detail with reference to the attached drawings, which show:

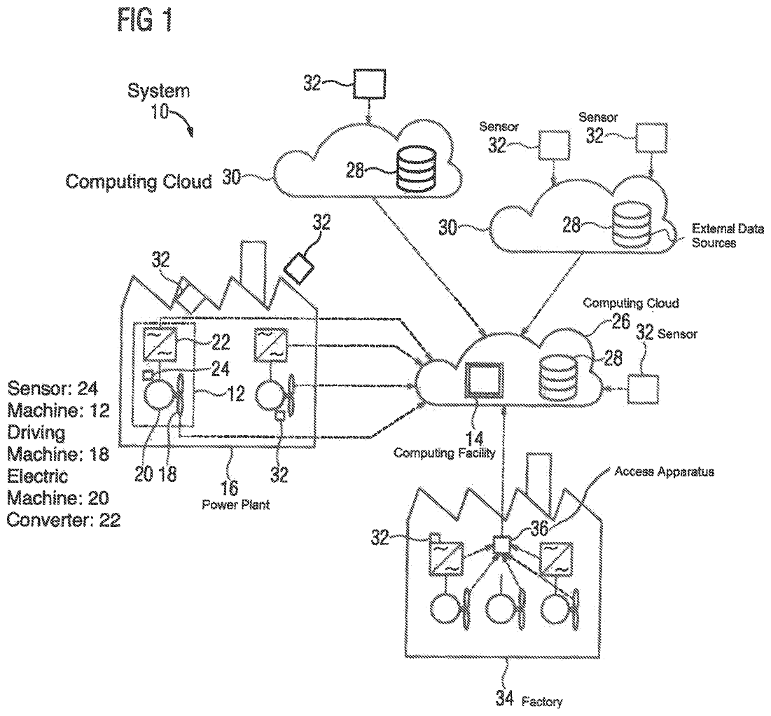

FIG. 1 a schematic representation of a system with a machine and a computing facility according to an exemplary embodiment;

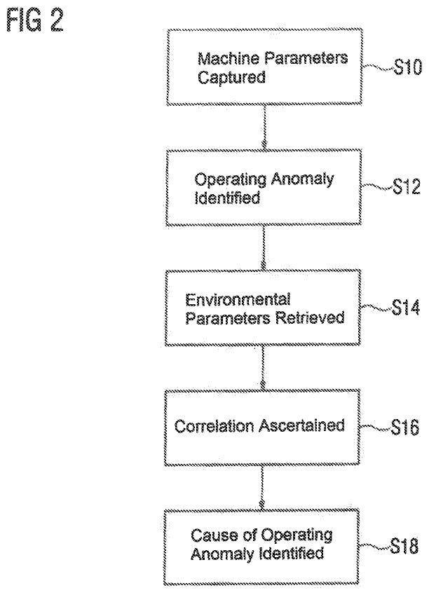

FIG. 2 a block diagram of a method according to an exemplary embodiment.

The exemplary embodiments described in more detail below represent preferred embodiments of the present invention. However, they should not be regarded as being restrictive.

FIG. 1 depicts a system 10 with a machine 12 and a computing facility 14 according to an exemplary embodiment. In this exemplary embodiment, the machine 12 can be arranged in a power plant 16 and comprise, for example, a driving machine 18, an electric machine 20 and a converter 22. In addition, the machine 20 can have at least one sensor 24 that can be embodied to capture one or more machine parameters.

The machine parameters can include measurement data of the machine 12 that monitors correct operation of the machine 12, In particular, the machine parameters can be used to identify an operating anomaly of the machine 12. For example, the sensor 24 can identify that the machine 12 is being operated in a critical temperature range.

To identify the cause of this operating anomaly, the computing facility 14 can be embodied to retrieve the machine parameters from the machine 12. Preferably, the computing facility 14 can be provided in a computing cloud 26 that can access the machine parameters of the machine 12, In addition, the computing facility 14 can be embodied to retrieve environmental parameters from at least one external data source 28. The one or more external data sources 28 can comprise databases, which can, for example, be provided in further computing clouds 30. The environmental parameters from the external data sources 28 can be measured, for example, by external environmental sensors 32, wherein external environmental sensors 32 can, for example, comprise sensors for determining the weather/climate and, for example, be arranged outside the power plant 16 and/or inside the power plant 16. For example, the external environmental sensors 32 can also be provided in another machine in the power plant 16.

Preferably, the environmental parameters can comprise further macroscopic data that can be stored in the one or more external data sources 28. For example, the external data source 28 can comprise economic information, such as, for example, local energy costs, information from utility companies about grid problems and voltage fluctuations and/or information from social networks. Preferably, environmental parameters can also be retrieved from another power plant or factory 34, wherein environmental parameters about the factory 34 can, for example, be obtained via an access apparatus 36 (edge device or gateway).

To retrieve the environmental parameters from the external data sources 28, the computing facility 14 can first homogenize the environmental parameters, This means that the computer facility 14 can filter the environmental parameters at least in dependence on a location of the machine 12 and/or a measurement time of the machine parameters. Hence, environmental parameters that may possibly be related to the anomaly can be filtered out of the heterogeneous data sources 28. The location of the machine and/or the measurement time of the machine parameters, can, for example, be held in a correlation model on the computing facility, wherein the correlation model can additionally comprise known relationships and/or known constraints of the environmental parameters and the captured machine parameters for the operating anomaly. Hence, data can be prefiltered for the correlation model data, as a result of which computing power and computing time of the computing facility 14 can be limited.

The computing facility 14 is furthermore embodied to ascertain at least one correlation between the machine parameters, the filtered environmental parameters and the operating anomaly by means of the correlation model. For this purpose, it is, on the one hand, possible to search for known correlations, preferably by means of artificial intelligence that examines the machine parameters and the environmental parameters in dependence on a predetermined correlation pattern and finds known correlations in an automated manner. On the other hand, statistical analysis, in particular regression analysis, can ascertain an unknown correlation, wherein the correlation model can be adapted by a machine learning function when this new unknown correlation is found. Hence, the new correlation can be provided as a predetermined correlation pattern for the artificial intelligence for subsequent determinations of the cause of the operating anomaly, as a result of which computing effort can be reduced.

If at least one correlation between the machine parameters, the filtered environmental parameters and the operating anomaly is identified, this correlation can be used to determine the cause of the operating anomaly. In particular, when the cause is identified, it is possible to make different diagnoses and forecasts with which proposals for optimization or action can be provided. Particularly preferably, it can be provided that the computing facility 14 is embodied to generate a control signal with which a machine function of the machine 12 can be generated in dependence on the detected cause of the operating anomaly, for example a shutdown of the machine, in order to prevent damage. Alternatively or additionally, it is also possible, for example. for other machines in the power plant 16 to be actuated by means of the control signal when the cause of the operating anomaly is detected in order to prevent damage to these machines as well. Alternatively, it can be provided that only a control signal for alerting is provided and this can be sent to the machine 12 and/or the power plant 16.

FIG. 2 is a method diagram for determining a cause of an operating anomaly of a machine 12 according to an exemplary embodiment, In Step S10, machine parameters are captured by at least one sensor 24 of the machine 12. In Step S12, the operating anomaly is identified from the captured machine parameters. In Step S14, environmental parameters are retrieved from at least one external data source 28 and the captured machine parameters are retrieved by a computing facility 14, wherein the environmental parameters are filtered at least in dependence on a location of the machine and/or a measurement time of the machine parameters.

In Step S16, at least one correlation between the machine parameters, the filtered environmental parameters and the operating anomaly is ascertained by means of a correlation model by the computing facility 14. Finally, in Step S18, the cause of the operating anomaly is determined based on the at least one correlation ascertained by the correlation model.

In particular, the method can advantageously support a user of a machine in the following scenarios: a temperature sensor of a machine can, for example, heat up due to solar radiation, as a result of which, for example, a safety function of the machine can prevent the machine from being switched on even though there is no unacceptable heating of the machine. An on-site operator may not be able to understand whether this entails a fault with the sensor or an operating anomaly. However, the method can determine a correlation between the heating and the solar radiation and the operator can determine that there is no harmful cause. In other cases, flooding can result in cooling and this means a temperature signal can be low even though the machine is running at full load and an operator would expect a higher operating temperature. Herein, the temperature can be harmless, but flooding could cause water damage to the machine and the operator can take appropriate action by being aware of this.

It is also, for example, possible that a faulty temperature sensor may not display a temperature, as a result of which no protective function is triggered due to excessive temperatures in the machine. However, this can advantageously be identified by means of the environmental parameters and action taken. In addition, energy costs can fluctuate locally based on supply and demand, wherein an operator can decide to stop the machine temporarily, which can lead to increased mechanical wear and tear and temperature cycles due to repeated stops and starts. These and further operating anomalies can be identified by means of the method and the causes can be acted upon, hi particular, it can be identified whether this entails a warranty case, an insurance case, a case of wear and tear or incorrect operation of the machine,

Overall, the examples show how the invention can provide a context-based expert system for machines, in particular for drives,

1.-11 (canceled)

12. A method for determining a cause of an operating anomaly of a machine, the method comprising:
capturing machine parameters by a sensor of the machine;
identifying the operating anomaly from the captured machine parameters;
retrieving environmental parameters from an external data source and the captured machine parameters by a computing facility, wherein the external data source is embodied as a cloud computing comprising one or more computers and/or servers that record macroscopic data about an environment using sensors external to the machine, wherein the environmental parameters are filtered at least in dependence on a location of the machine and/or a measurement time of the machine parameters;
ascertaining a correlation between the machine parameters, the filtered environmental parameters and the operating anomaly by the computing facility by a correlation model, wherein the correlation model is embodied to determine the correlation based on machine parameters and the environmental parameters by a statistical analysis and by a predetermined correlation pattern;
determining the cause of the operating anomaly based on the correlation ascertained by the correlation model; and
adapting the correlation model by a machine learning function when a new correlation is detected for the cause of the operating anomaly.

13. The method of claim 12, further comprising ascertaining the correlation by statistical analysis.

14. The method of claim 13, further comprising performing regression analysis as statistical analysis.

15. The method of claim 13, further comprising modeling the correlation model in dependence on known relationships and/or known constraints.

16. The method of claim 15, further comprising adapting the correlation model by a machine learning function if a new correlation is detected for the cause of the operating anomaly.

17. The method of claim 15, further comprising determining the cause of the operating anomaly in dependence on a predetermined correlation pattern by the computing facility by artificial intelligence, and examining the machine parameters and the environmental parameters for the presence of the predetermined correlation pattern.

18. The method of claim 15, further comprising measuring the environmental parameters by external environmental sensors.

19. The method of claim 15, further comprising generating a control signal, with which a machine function of the machine or another machine is actuated, in dependence on the cause of the operating anomaly.

20. A system for determining a cause of an operating anomaly of a machine, the system comprising:
a machine configured to capture machine parameters by a sensor and to identify an operating anomaly from the captured machine parameters; and
a computing facility configured to retrieve environmental parameters from an external data source, the external data source embodied as cloud computing comprising one or more computers and/or servers that record macroscopic data about an environment using sensors external to the machine, the computing facility further configured to retrieve the captured machine parameters, to filter environmental parameters in dependence on a location of the machine and/or a measurement time of the machine parameters, to ascertain a correlation between the machine parameters, the filtered environmental parameters and the operating anomaly by a correlation model, wherein the correlation model is configured to ascertain the correlation based on the machine parameters and the environmental parameters by a statistical analysis and by a predetermined correlation pattern, and to determine the cause of the operating anomaly based on the correlation ascertained by the correlation model, and when a new correlation is detected for the cause of the operating anomaly, to adapt the correlation model by a machine learning function.

21. A computer program product, which can be loaded directly into a memory of a computing facility, with program code for executing steps of the method of claim 12 when the program is executed in the computing facility.

22. An electronically readable data storage device with readable control information stored thereupon, which comprises a computer program with program code for executing steps of the method of claim 12 when the data storage device is used in a computing facility.
